(19) United States
(12) Patent Application Publication
(10) Pub. No.: US 2024/0329950 A1
(43) Pub. Date: Oct. 3, 2024

(54) METHOD, APPARATUS, DEVICE AND STORAGE MEDIUM FOR WEBPAGE RENDERING

(71) Applicant: BEIJING BYTEDANCE NETWORK TECHNOLOGY CO., LTD., Beijing (CN)

(72) Inventors: Weihao Tang, Beijing (CN); Min Zhang, Beijing (CN); Na Zhai, Beijing (CN); Dian Xiong, Beijing (CN); Xuemei Zhou, Beijing (CN); Yixian Li, Beijing (CN)

(21) Appl. No.: 18/573,991

(22) PCT Filed: Sep. 21, 2022
(86) PCT No.: PCT/CN2022/120134

§ 371 Date: Dec. 22, 2023

(30) Foreign Application Priority Data
Oct. 28, 2021 (CN) 202111264965.8

(51) Int. Cl. G06F 8/41; G06F 8/30

(52) U.S. Cl. CPC G06F 8/427; G06F 8/31

(57) ABSTRACT

This application discloses a method, apparatus, device, and storage medium for webpage rendering. A layout program code corresponding to the webpage is obtained; wherein the layout program code is written with at least one of imperative syntax and declarative syntax; the layout program code is parsed to obtain a tree component structure; wherein the tree component structure is composed of at least two components; layout information of the webpage is calculated based on the tree component structure and is added to the tree component structure; in response to determining that a rendering operation on the webpage is triggered, hybrid rendering of at least two components in the tree component structure with added layout information is performed from top to bottom.

### CROSS REFERENCE

This application is the U.S. National Stage of International Application No. PCT/CN2022/120134, filed on Sep. 21, 2022, which claims priority to Chinese Patent Application No. 202111264965.8 filed with the Chinese Patent Office on Oct. 28, 2021, the disclosures of which are incorporated herein by reference in their entities.

### FIELD

Embodiments of the present disclosure relate to the field of Internet technology, e.g., relating to a method, apparatus, device, and storage medium for webpage rendering.

### BACKGROUND

With the development of Web technology and the landing of HTML5 standards, HTML5 development becomes increasingly popular. HTML5 development has such advantages as cross-platform, low development cost, fast iteration and easy dynamic publishing, and its proportion in mobile App development is increasing. Elements, as an important characteristic of HTML5, play an indispensable role in mobile development page presentation, especially in image processing, animation presentation and other occasions.

### SUMMARY

The embodiments of the present disclosure provide a method, apparatus, device, and storage medium for webpage rendering, which can reduce the cost of page development, improve the efficiency of page development, and further realize hybrid rendering.

In a first aspect, the embodiments of the present disclosure provide a method of webpage rendering, comprising:
obtaining a layout program code corresponding to the webpage; wherein the layout program code is written with at least one of imperative syntax and declarative syntax;
parsing the layout program code to obtain a tree component structure; wherein the tree component structure is composed of at least two components;
calculating layout information of the webpage based on the tree component structure and adding the layout information to the tree component structure;
in response to determining that a rendering operation on the webpage is triggered, performing hybrid rendering of at least two components in the tree component structure with added layout information from top to bottom.

In a second aspect, the embodiments of the present disclosure further provide an apparatus for webpage rendering, comprising:
a layout program code obtaining module, configured for obtaining a layout program code corresponding to the webpage; wherein the layout program code is written with at least one of imperative syntax and declarative syntax;
a tree component structure obtaining module, configured for parsing the layout program code to obtain a tree component structure; wherein the tree component structure is composed of at least two components;
a layout information obtaining module, configured for calculating layout information of the webpage based on the tree component structure and adding the layout information to the tree component structure;
a rendering module, configured for, in response to determining that a rendering operation on the webpage is triggered, performing hybrid rendering of at least two components in the tree component structure with added layout information from top to bottom.

In a third aspect, the embodiments of the present disclosure further provide an electronic device, the electronic device comprising:
one or more processing means;
storage means, configured for storing one or more programs;
the one or more programs, when executed by the one or more processing means, causing the one or more processing means to perform the webpage rendering method described above.

In a fourth aspect, the embodiments of the present disclosure further provide a computer-readable medium, on which a computer program is stored, the program, when executed by processing means, performing the webpage rendering method described above.

### BRIEF DESCRIPTION OF THE DRAWINGS

FIG. 1 is a flowchart of a webpage rendering method in an embodiment of the present disclosure;

FIG. 2 is a structural schematic diagram of implementing a self-drawing component in an embodiment of the present disclosure;

FIG. 3 is a principle diagram of implementing hybrid rendering in an embodiment of the present disclosure;

FIG. 4 is a structural schematic diagram of a webpage rendering apparatus in an embodiment of the present disclosure; and

FIG. 5 is a structural schematic diagram of an electronic device in an embodiment of the present disclosure.

### DETAILED DESCRIPTION

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise” and its variants used here are to be read as open terms that mean “include, but is not limited to”. The term “based on” is to be read as “based at least in part on”. The term “one embodiment” are to be read as “at least one embodiment”. The term “another embodiment” is to be read as “at least one other embodiment”. The term “some embodiments” are to be read as “at least some embodiments”. Other definitions will be presented in the description below.

Note that the concepts “first”, “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more”.

Names of messages or information interacted between a plurality of means in the implementations of the present disclosure are merely for the illustration purpose, rather than limiting the scope of these messages or information.

Conventionally, the rendering of webpages faces the following problems: the implementation of page layout by instruction methods involves high page development costs and low efficiency; hybrid rendering of 2D graphics and ordinary page elements cannot be realized. To solve at least one or more of the problems, embodiments of the present disclosure provide a solution for webpage rendering.

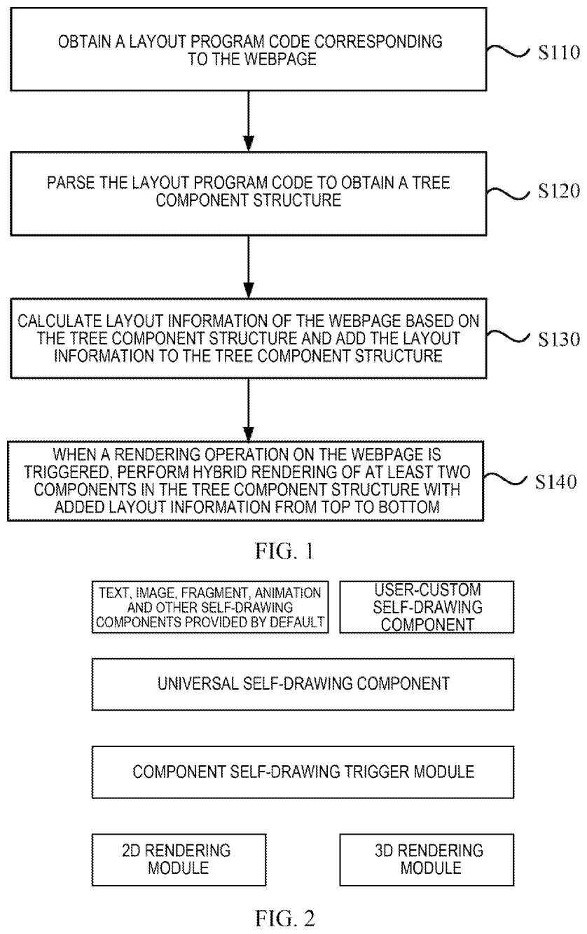

FIG. 1 is a flowchart of a webpage rendering method provided by an embodiment of the present disclosure. This embodiment is applicable to the case of rendering a web page. The method may be performed by a webpage rendering apparatus, which may be composed of hardware and/or software and may generally be integrated in a device with webpage rendering functionality. The device may be an electronic device such as a server, a mobile terminal, or a server cluster. As shown in FIG. 1, the method comprises the following steps:

Step 110: obtaining a layout program code corresponding to the webpage.

Wherein, the layout program code is written with imperative syntax and/or declarative syntax. The layout program code is a program code encoded by the page developer according to the development requirements, which can use imperative syntax (such as pixi.js syntax) or declarative syntax or both at the same time. In this embodiment, the layout program code can be applied to the rendering of Canvas webpages. Canvas web pages support declarative syntax, and declarative syntax has the characteristic of lightweight. Therefore, the rendering of Canvas web pages by using the layout program code written with declarative syntax avoids the situation where the access cost of Canvas webpages is high for developers, and reduces the space cost of page development. For example, the layout program code corresponding to the webpage can be obtained through a program call interface.

Step 120: parsing the layout program code to obtain a tree component structure.

Wherein, the tree-shaped component structure consists of at least two components, including: self-drawing components, webpage components, and WebGL components. Self-drawing components can be components drawn by users through self-drawing interfaces, and their attributes can be customized, including dimension, color, shape, etc.; webpage components can also be called web components, including various common interface components, such as tables, trees, linked drop-down boxes, etc.; WebGL components can be understood as 3D components.

FIG. 2 is a structural schematic diagram of implementing a self-drawing component in this embodiment. As shown in FIG. 2, the user can customize the general self-drawing component through the self-drawing interface (referred to as a component self-drawing trigger module in the figure) to obtain a custom self-drawing component. For example, assuming a component that implements a rotation button, the user can customize the rotation direction and speed of the rotation button to obtain a new rotation button component. For the rendering of the self-drawing component, as shown in FIG. 2, it can be rendered using either a 2D rendering module (such as the Context rendering module) or a 3D rendering module (such as the WebGL rendering module).

In this embodiment, the process of parsing the layout program code can be understood as the process of obtaining component nodes and the hierarchical relationship between component nodes by parsing the layout program code, thereby establishing a tree component structure based on the hierarchical relationship between component nodes.

Step 130: calculating layout information of the webpage based on the tree component structure and adding the layout information to the tree component structure.

Wherein, the layout information can include the dimensions of a plurality of components, the position information of components on the page, and the relative positional relationship between components. For example, the layout information can be calculated by using the style declaration information of a plurality of components in the tree component structure.

For example, after calculating the layout information of the webpage based on the tree component structure, there are further comprised: if the tree component structure is associated with layout middleware, executing the layout middleware, obtaining additional layout information, and adding the additional layout information to the tree component structure.

Wherein, the layout middleware can be associated with the tree component structure through a hook function. If the additional layout information is an extension of the layout of a certain component, the layout middleware is associated with the node where the component is located through the hook function. For example, after calculating the layout information of the webpage according to the tree component structure, the associated layout middleware is executed in order from top to bottom of the tree component structure to obtain additional layout information, and the additional layout information is added to the associated component node. For example, the layout middleware can be hierarchical relationship calculation middleware. In this embodiment, the functionality of a rendering tool can be extended through the layout middleware. For functions that cannot be achieved by the rendering tool, they can be achieved through the layout middleware.

Step 140: when a rendering operation on the webpage is triggered, performing hybrid rendering of at least two components in the tree component structure with added layout information from top to bottom.

The triggering method of the rendering operation can be triggered by user switching pages, user sliding pages, or automatic periodic triggering. In this embodiment, since the tree component structure contains at least two components, different rendering modules need to be called for different types of components for rendering.

For example, if the component is a self-drawing component, the self-drawing component is self-drawing rendered; if the component is a webpage component or WebGL component, the hybrid rendering middleware is called to render the webpage component or WebGL component. In this embodiment, the hybrid rendering of Canvas webpages and ordinary webpages is realized by calling the hybrid rendering middleware.

Wherein, self-drawing rendering can directly call the 2D rendering module or 3D rendering module embedded in the rendering tool. For web components or WebGL components, rendering tools cannot be directly called, so the hybrid rendering middleware can be called to render web components or WebGL components.

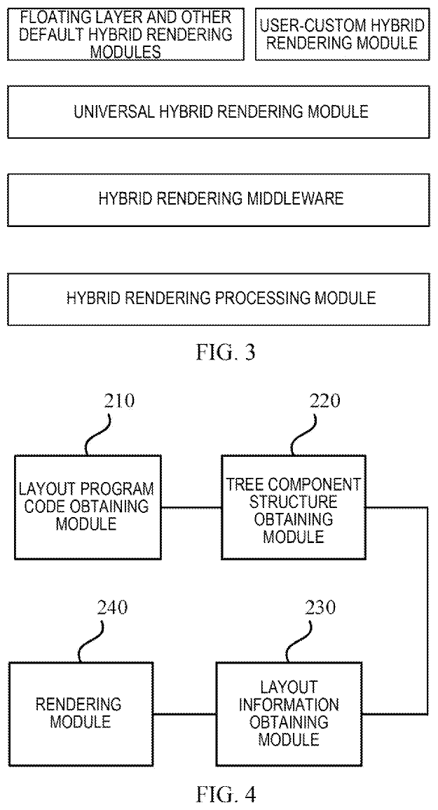

The hybrid rendering middleware is provided with a hybrid rendering module, which can implement hybrid rendering functions. As an example, FIG. 3 is a principle diagram of implementing hybrid rendering in this embodiment. As depicted, the hybrid rendering module can include default hybrid rendering modules such as a universal hybrid rendering module and a floating layer, as well as a custom hybrid rendering module. The hybrid rendering processing module can understand the calling interface to the hybrid rendering middleware.

For example, after adding the layout information to the tree component structure, there is further comprised: saving the tree component structure with added layout information to a memory.

In this embodiment, saving the tree component structure to a memory can not only achieve multiple renderings of web pages but also facilitate subsequent response to event operations. In addition, this embodiment is applied to Canvas web pages. By saving the tree component structure to a memory, the event triggering mechanism in Canvas web pages is realized, thereby avoiding scrolling response and mouse response of Canvas web pages.

Accordingly, when the rendering operation on the webpage is triggered, the process of hybrid rendering of at least two components in the tree component structure with added layout information from top to bottom can be: when the rendering operation on the webpage is triggered, hybrid rendering of at least two components in the tree component structure in memory from top to bottom.

For example, after saving the tree component structure with added layout information to memory, the following steps are further comprised: when an event operation on the webpage is triggered, obtaining first position information of the event operation; determining a target component from the tree component structure based on the first position information; controlling the target component to perform the event operation.

Wherein, the event operation can be triggered by the user, such as click events and drag events. The first position information can be position information on the page. The target component can be understood as a component whose position information matches the first position information. Matching can be understood as a component whose first position information is at the position of the target component or has a linkage relationship with a component located in the first position information.

For example, the method of determining the target component from the tree component structure based on the first position information can be: traversing components in the tree component structure from top to bottom, comparing position information of the traversed component with the first position information, and if the position information of the traversed component matches the first position information, determining the traversed component as the target component and stopping traversing the next component.

In this embodiment, all of the plurality of components carry position information, and the position information of the traversed component is compared with the first position information. If the first position information is at the position of the traversed component or the traversed component has a linkage relationship with a component located in the first position information, the traversed component is the target component. After the target component is found, the traversal of the next component can be stopped. According to the technical solution of this embodiment, when the target component is found, the traversal of the next component is stopped, that is, the first position information is only compared with the position information of the traversed component, without comparing with the position information of all components in the tree component structure. Thereby, not only the computation amount can be reduced, but also time and system resources can be saved, improving the efficiency of webpage rendering.

For example, the method of determining the target component from the tree component structure based on the first position information can be: comparing the position information of a plurality of components in the tree component structure with the first position information, and determining the component whose position information matches the first position information as the target component.

In this embodiment, first, the position information of the plurality of components is extracted, and then the extracted position information is compared with the first position information respectively. This method directly compares the extracted position information of the plurality of components in the tree component structure with the first position information, without traversing the tree component structure. Thereby, the method can quickly determine the target component, improving the efficiency of webpage rendering.

In this embodiment, after determining the target component, a graphic element corresponding to the target component is controlled to perform the event operation. For example, assuming it is a drag event, the graphic element corresponding to the target component is dragged.

The technical solution of the embodiments of the present disclosure obtains a layout program code corresponding to the webpage, wherein the layout program code is written with imperative syntax and/or declarative syntax; parses the layout program code to obtain a tree component structure, wherein the tree component structure is composed of at least two components; calculates layout information of the webpage according to the tree component structure, and adds the layout information to the tree component structure; when a rendering operation on the webpage is triggered, performs hybrid rendering of at least two components in the tree component structure with added layout information from top to bottom. With the webpage rendering method provided by the embodiments of the present disclosure, the layout program code is written with imperative syntax and/or declarative syntax, which can reduce the cost of page development, improve the efficiency of page development, and achieve hybrid rendering.

FIG. 4 is a structural schematic diagram of a web page rendering apparatus provided by an embodiment of the present disclosure. As shown in FIG. 4, the apparatus comprises:

a layout program code obtaining module 210, configured for obtaining a layout program code corresponding to the webpage; wherein the layout program code is written with imperative syntax and/or declarative syntax;

a tree component structure obtaining module 220, configured for parsing the layout program code to obtain a tree component structure; wherein the tree component structure is composed of at least two components;
a layout information obtaining module 230, configured for calculating layout information of the webpage based on the tree component structure and adding the layout information to the tree component structure;
a rendering module 240, configured for performing hybrid rendering of at least two components in the tree component structure with added layout information from top to bottom when a rendering operation on the webpage is triggered.

For example, the webpage rendering apparatus further comprises: a layout middleware execution module, configured for:
if the tree component structure is associated with layout middleware, executing the layout middleware, obtaining additional layout information, and adding the additional layout information to the tree component structure.

For example, the webpage rendering apparatus further comprises: an event operation execution module, configured for:
when an event operation on the webpage is triggered, obtaining first position information of the event operation;
determining a target component from the tree component structure based on the first position information;
controlling the target component to perform the event operation.

For example, the event operation execution module is also configured for:
traversing components in the tree component structure from top to bottom, comparing the position information of the traversed component with the first position information, and if the position information of the traversed component matches the first position information, determining the traversed component as the target component and stop traversing the next component.

For example, the event operation execution module is also configured for:
comparing the position information of a plurality of components in the tree component structure with the first position information, and determining the component whose position information matches the first position information as the target component.

For example, the at least two components comprise: self-drawing components, webpage components, and WebGL components; the rendering module 250 is also configured for:
if the component is a self-drawing component, self-drawing rendering the self-drawing component;
if the component is a webpage component or a WebGL component, calling hybrid rendering middleware to render the webpage component or WebGL component.

For example, the webpage rendering apparatus further comprises: a self-drawing module, configured for:
receiving user-custom settings for a universal self-drawing component through a self-drawing interface to obtain a custom self-drawing component.

For example, the apparatus for webpage rendering further comprises: a saving module, configured for:
saving the tree component structure with added layout information to a memory.

For example, the rendering module 240 is further configured for:
when a rendering operation on the webpage is triggered, performing hybrid rendering of at least two components in the tree component structure in the memory from top to bottom.

The above apparatus can perform the method provided in all the aforementioned embodiments of the present disclosure, with the corresponding functional modules and effects of the execution method. Technical details that are not described in this embodiment can be found in the method provided in all the aforementioned embodiments of the present disclosure.

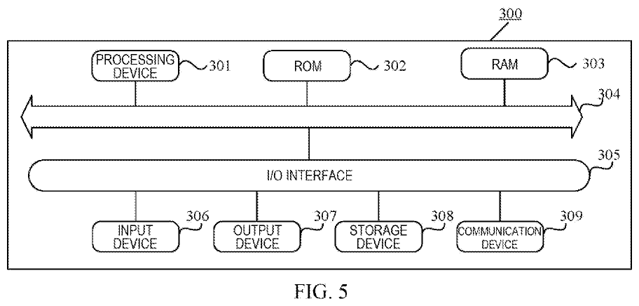

Referring now to FIG. 5, there is shown a schematic diagram of the structure of an electronic device 300 suitable for implementing an embodiment of the disclosure. The electronic devices in the disclosure may include but are not limited to mobile end points such as mobile phones, laptops, digital broadcast receivers, PDAs (personal digital assistants), PADs (tablets), PMPs (portable multimedia players), car end points (such as car navigation end points), etc., as well as fixed end points such as digital TVs, desktop computers, etc., or various forms of servers such as stand-alone servers or server clusters. The electronic device shown in FIG. 5 is only an example and should not bring any limitation on the functionality and scope of use of the disclosed embodiments.

As shown in FIG. 5, the electronic device 300 may include a processing device (such as a Central Processor, graphics processing unit, etc.) 301, which can perform various appropriate actions and processes based on programs stored in a read-only storage device (ROM) 302 or loaded from storage device 305 into a random access storage device (RAM) 303. In RAM 303, various programs and data required for the operation of the electronic device 300 are also stored. Processing devices 301, ROM 302, and RAM 303 are connected to each other through bus 304. Input/output (I/O) interface 305 is also connected to bus 304.

Typically, the following devices can be connected to I/O interface 305: input devices 306 including touch screens, touchpads, keyboards, mice, cameras, microphones, accelerometers, gyroscopes, etc.; output devices 307 including liquid crystal displays (LCDs), speakers, vibrators, etc.; storage devices 308 including magnetic tapes, hard disks, etc.; and communication devices 309. Communication devices 309 can allow electronic devices 300 to communicate wirelessly or wirelessly with other devices to exchange data. Although FIG. 5 shows an electronic device 300 with multiple devices, it should be understood that it is not required to implement or have all of the devices shown. More or fewer devices can be implemented or provided alternatively.

According to the embodiments of the present disclosure, the process described above with reference to the flowchart can be implemented as a computer software program. For example, embodiments of the present disclosure include a computer program product that includes a computer program carried on a computer-readable medium, the computer program containing program code for executing a rendering method of a web page. In such embodiments, the computer program can be downloaded and installed from the network through the communication device 309, or installed from the storage device 305, or installed from the ROM 302. When the computer program is executed by the processing device 301, the above functions defined in the methods of the present disclosure are performed. The computer-readable medium can be a non-transitory computer-readable medium.

It should be noted that the computer-readable medium described above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device, or any combination thereof. More specific examples of computer-readable storage media can include but are not limited to: an electrical connection with one or more wires, a portable computer disk, a hard disk, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In this disclosure, a computer-readable storage medium can be any tangible medium containing or storing a program that can be used by or in conjunction with an instruction execution system, device, or device. In this disclosure, a computer-readable signal medium can include a data signal propagated in a baseband or as part of a carrier wave, which carries computer-readable program code. Such propagated data signals can take many forms, including but not limited to electromagnetic signals, optical signals, or any suitable combination thereof. Computer-readable signal media can also be any computer-readable medium other than computer-readable storage media, which can send, propagate, or transmit programs for use by or in conjunction with instruction execution systems, devices, or devices. The program code contained on the computer-readable medium can be transmitted using any suitable medium, including but not limited to: wires, optical cables, RF (radio frequency), etc., or any suitable combination thereof.

In some implementation methods, clients and servers can communicate using any currently known or future developed network protocol such as HTTP (HyperText Transfer Protocol), and can interconnect with any form or medium of digital data communication (such as communication networks). Examples of communication networks include local area networks (LANs), wide area networks (WANs), the Internet (such as the Internet), and end-to-end networks (such as ad hoc end-to-end networks), as well as any currently known or future developed networks.

The computer-readable medium can be included in the electronic device, or it can exist alone and not assembled into the electronic device.

The computer-readable medium carries one or more programs, and when the one or more programs are executed by the electronic device, the electronic device: obtaining a layout program code corresponding to the webpage; wherein the layout program code is written with at least one of imperative syntax and declarative syntax; parsing the layout program code to obtain a tree component structure; wherein the tree component structure is composed of at least two components; calculating layout information of the webpage based on the tree component structure and adding the layout information to the tree component structure; and in response to determining that a rendering operation on the webpage is triggered, performing hybrid rendering of at least two components in the tree component structure with added layout information from top to bottom.

Computer program code for performing the operations of the present disclosure may be written in one or more programming languages, or combinations thereof, including but not limited to Object Oriented programming languages such as Java, Smalltalk, C++, and also including conventional procedural programming languages such as “C” language or similar programming languages. The program code may be executed entirely on the user's computer, partially on the user's computer, as a standalone software package, partially on the user's computer, or entirely on a remote computer or server. In the case of a remote computer, the remote computer may be connected to the user's computer through any type of network, including a local area network (LAN) or a wide area network (WAN), or may be connected to an external computer (e.g., using an Internet service provider to connect via the Internet).

The flowcharts and block diagrams in the accompanying drawings illustrate the architecture, functions, and operations of the system, method, and computer program product that may be implemented in accordance with various embodiments of the present disclosure. In this regard, each block in the flowcharts or block diagrams may represent a module, program segment, or portion of code that contains one or more executable instructions for implementing a specified logical function. It should also be noted that in some alternative implementations, the functions marked in the blocks may also occur in a different order than those marked in the drawings. For example, two consecutive blocks may actually be executed substantially in parallel, and they may sometimes be executed in the opposite order, depending on the function involved. It should also be noted that each block in the block diagrams and/or flowcharts, as well as combinations of blocks in the block diagrams and/or flowcharts, may be implemented using a dedicated hardware-based system that performs the specified function or operation, or may be implemented using a combination of dedicated hardware and computer instructions.

The units described in the disclosed embodiments can be implemented by software or by hardware. The name of the unit does not limit the unit itself in some cases.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), system-on-chip (SOCs), complex programmable logic devices (CPLDs), and the like.

In the context of this disclosure, machine-readable media can be tangible media that can contain or store programs for use by or in conjunction with instruction execution systems, devices, or devices. Machine-readable media can be machine-readable signal media or machine-readable storage media. Machine-readable media can include, but are not limited to, electronic, magnetic, optical, electromagnetic, infrared, or semiconductor systems, devices, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, the present disclosure discloses a method of webpage rendering, comprising:
obtaining a layout program code corresponding to the webpage; wherein the layout program code is written with at least one of imperative syntax and declarative syntax;
parsing the layout program code to obtain a tree component structure; wherein the tree component structure is composed of at least two components;
calculating layout information of the webpage based on the tree component structure and adding the layout information to the tree component structure.
in response to determining that a rendering operation on the webpage is triggered, performing hybrid rendering of at least two components in the tree component structure with added layout information from top to bottom.

For example, after calculating the layout information of the webpage according to the tree component structure, further comprising:
in response to determining that the tree component structure is associated with layout middleware, executing the layout middleware, obtaining additional layout information, and adding the additional layout information to the tree component structure.

For example, after saving the tree component structure with added layout information to a memory, further comprising:
in response to determining that an event operation on the webpage is triggered, obtaining first position information of the event operation;
determining a target component from the tree component structure based on the first position information;
controlling the target component to perform the event operation.

For example, determining a target component from the tree component structure based on the first position information comprises:
traversing components in the tree component structure from top to bottom, comparing the position information of the traversed component with the first position information, and in response to determining that the position information of the traversed component matches the first position information, determining the traversed component as the target component and stopping traversing the next component.

For example, the determining a target component from the tree component structure based on the first position information comprises:
comparing the position information of the at least two components in the tree component structure with the first position information respectively, and determining the component whose position information matches the first position information as the target component.

For example, the at least two components comprise: self-drawing components, webpage components, and WebGL components; the performing hybrid rendering of at least two types of components in the tree component structure with added layout information from top to bottom comprises:
in response to determining that a component is a self-drawing component, self-drawing rendering the self-drawing component;
in response to determining that a component is a webpage component or a WebGL component, calling hybrid rendering middleware to render the webpage component or WebGL component.

For example, the method of webpage rendering further comprising:
receiving user-custom settings for a universal self-drawing component through a self-drawing interface to obtain a custom self-drawing component.

For example, after adding the layout information to the tree component structure, further comprising:
saving the tree component structure with added layout information to a memory;
the performing hybrid rendering of at least two components in the tree component structure with added layout information from top to bottom in response to determining that a rendering operation on the webpage is triggered comprising:
in response to determining that a rendering operation on the webpage is triggered, performing hybrid rendering of at least two components in the tree component structure in the memory from top to bottom.

1. A method of webpage rendering, comprising:
obtaining a layout program code corresponding to the webpage; wherein the layout program code is written with at least one of imperative syntax and declarative syntax;
parsing the layout program code to obtain a tree component structure; wherein the tree component structure is composed of at least two components;
calculating layout information of the webpage based on the tree component structure and adding the layout information to the tree component structure; and
in response to determining that a rendering operation on the webpage is triggered, performing hybrid rendering of at least two components in the tree component structure with added layout information from top to bottom.

2. The method of claim 1, after calculating the layout information of the webpage according to the tree component structure, further comprising:
in response to determining that the tree component structure is associated with layout middleware, executing the layout middleware, obtaining additional layout information, and adding the additional layout information to the tree component structure.

3. The method of claim 1, after saving the tree component structure with added layout information to a memory, further comprising:
in response to determining that an event operation on the webpage is triggered, obtaining first position information of the event operation;
determining a target component from the tree component structure based on the first position information; and
controlling the target component to perform the event operation.

4. The method of claim 3, wherein the determining a target component from the tree component structure based on the first position information comprises:
traversing components in the tree component structure from top to bottom, comparing the position information of the traversed component with the first position information, and in response to determining that the position information of the traversed component matches the first position information, determining the traversed component as the target component and stopping traversing the next component.

5. The method of claim 3, wherein the determining a target component from the tree component structure based on the first position information comprises:
comparing the position information of the at least two components in the tree component structure with the first position information respectively, and determining the component whose position information matches the first position information as the target component.

6. The method of claim 1, wherein the at least two components comprise: self-drawing components, webpage components, and WebGL components; the performing hybrid rendering of at least two types of components in the tree component structure with added layout information from top to bottom comprises:
in response to determining that a component is a self-drawing component, self-drawing rendering the self-drawing component; and
in response to determining that a component is a webpage component or a WebGL component, calling hybrid rendering middleware to render the webpage component or WebGL component.

7. The method of claim 1, further comprising:
receiving user-custom settings for a universal self-drawing component through a self-drawing interface to obtain a custom self-drawing component.

8. The method of claim 1, after adding the layout information to the tree component structure, further comprising:
saving the tree component structure with added layout information to a memory,
the performing hybrid rendering of at least two components in the tree component structure with added layout information from top to bottom in response to determining that a rendering operation on the webpage is triggered comprising:
in response to determining that a rendering operation on the webpage is triggered, performing hybrid rendering of at least two components in the tree component structure in the memory from top to bottom.

9. (canceled)

10. An electronic device comprising:
at least one processing means;
storage means, configured for storing one or more programs;
the one or more programs, when executed by the at least one processing means, causing the at least one processing means to perform acts of webpage rendering, the acts comprising:
obtaining a layout program code corresponding to the webpage; wherein the layout program code is written with at least one of imperative syntax and declarative syntax;
parsing the layout program code to obtain a tree component structure; wherein the tree component structure is composed of at least two components;
calculating layout information of the webpage based on the tree component structure and adding the layout information to the tree component structure; and
in response to determining that a rendering operation on the webpage is triggered, performing hybrid rendering of at least two components in the tree component structure with added layout information from top to bottom.

11. A non-transitory computer-readable medium, on which a computer program is stored, the computer program, when executed by processing means, performing operations of webpage rendering, the operations comprising:
obtaining a layout program code corresponding to the webpage; wherein the layout program code is written with at least one of imperative syntax and declarative syntax;
parsing the layout program code to obtain a tree component structure; wherein the tree component structure is composed of at least two components;
calculating layout information of the webpage based on the tree component structure and adding the layout information to the tree component structure; and
in response to determining that a rendering operation on the webpage is triggered, performing hybrid rendering of at least two components in the tree component structure with added layout information from top to bottom.

12. The device of claim 10, wherein after calculating the layout information of the webpage according to the tree component structure, the acts further comprises:
in response to determining that the tree component structure is associated with layout middleware, executing the layout middleware, obtaining additional layout information, and adding the additional layout information to the tree component structure.

13. The device of claim 10, wherein after saving the tree component structure with added layout information to a memory, the acts further comprises:
in response to determining that an event operation on the webpage is triggered, obtaining first position information of the event operation;
determining a target component from the tree component structure based on the first position information; and
controlling the target component to perform the event operation.

14. The device of claim 13, wherein the determining a target component from the tree component structure based on the first position information comprises:
traversing components in the tree component structure from top to bottom, comparing the position information of the traversed component with the first position information, and in response to determining that the position information of the traversed component matches the first position information, determining the traversed component as the target component and stopping traversing the next component.

15. The device of claim 13, wherein the determining a target component from the tree component structure based on the first position information comprises:
comparing the position information of the at least two components in the tree component structure with the first position information respectively, and determining the component whose position information matches the first position information as the target component.

16. The device of claim 10, wherein the at least two components comprise: self-drawing components, webpage components, and WebGL components; the performing hybrid rendering of at least two types of components in the tree component structure with added layout information from top to bottom comprises:
in response to determining that a component is a self-drawing component, self-drawing rendering the self-drawing component; and
in response to determining that a component is a webpage component or a WebGL component, calling hybrid rendering middleware to render the webpage component or WebGL component.

17. The device of claim 10, wherein the acts further comprises:
receiving user-custom settings for a universal self-drawing component through a self-drawing interface to obtain a custom self-drawing component.

18. The device of claim 10, wherein after adding the layout information to the tree component structure, the acts further comprises:
saving the tree component structure with added layout information to a memory,
the performing hybrid rendering of at least two components in the tree component structure with added layout information from top to bottom in response to determining that a rendering operation on the webpage is triggered comprising:
in response to determining that a rendering operation on the webpage is triggered, performing hybrid rendering of at least two components in the tree component structure in the memory from top to bottom.

19. The non-transitory computer-readable medium of claim 11, wherein after calculating the layout information of the webpage according to the tree component structure, the acts further comprises:
in response to determining that the tree component structure is associated with layout middleware, executing the layout middleware, obtaining additional layout information, and adding the additional layout information to the tree component structure.

20. The non-transitory computer-readable medium of claim 11, wherein after saving the tree component structure with added layout information to a memory, the acts further comprises:
in response to determining that an event operation on the webpage is triggered, obtaining first position information of the event operation;
determining a target component from the tree component structure based on the first position information; and
controlling the target component to perform the event operation.

21. The non-transitory computer-readable medium of claim 20, wherein the determining a target component from the tree component structure based on the first position information comprises:
traversing components in the tree component structure from top to bottom, comparing the position information of the traversed component with the first position information, and in response to determining that the position information of the traversed component matches the first position information, determining the traversed component as the target component and stopping traversing the next component.
